(19) United States
(12) Patent Application Publication
(10) Pub. No.: US 2024/0268346 A1
(43) Pub. Date: Aug. 15, 2024

(54) PET GROOMING KIT

(71) Applicant: Furme Technology LLC, Wilmington, DE (US)

(72) Inventor: Matthew Homa, Dorado, PR (US)

(73) Assignee: Furme Technology LLC, Wilmington, DE (US)

(21) Appl. No.: 18/641,732

(22) Filed: Apr. 22, 2024

Related U.S. Application Data
(63) Continuation-in-part of application No. 18/379,549, filed on Oct. 12, 2023.
(63) Continuation-in-part of application No. 18/376,232, filed on Oct. 3, 2023.
Application No. 18/379,549 is a continuation-in-part of application No. 18/130,770, filed on Apr. 4, 2023.
Application No. 18/376,232 is a continuation-in-part of application No. 18/130,770, filed on Apr. 4, 2023.
(60) Provisional application No. 63/442,326, filed on Jan. 31, 2023.

(51) Int. Cl. A01K 13/00; A47L 7/00; A47L 9/00; A47L 9/12; A47L 9/14; A47L 9/24; A47L 9/32; B26B 19/44

(52) U.S. Cl. CPC A01K 13/002; A47L 7/0066; A47L 7/0095; A47L 9/0027; A47L 9/122; A47L 9/1427; A47L 9/242; A47L 9/327; B26B 19/44

(57) ABSTRACT

A pet grooming kit may include (a) a canister having a handle, a canister vacuum port, and a screen through which air can pass; (b) a base having a latch configured to releasably secure the canister to the base; a clip; a base vacuum port that is fluidly coupled to the canister vacuum port when the canister is releasably secured to the base; a filter; and a vacuum system that draws a vacuum through the vacuum port, the canister vacuum port, the screen and the filter; (c) a plurality of tools; and (d) a flexible hose having a vacuum-engaging end that is configured to be releasably coupled to the vacuum port and that has a vacuum-end power connection, a tool-engaging end that has a tool-end power connection and that is configured to either releasably secure one of the plurality of tools or be releasably secured by the clip.

### CROSS-REFERENCE TO RELATED APPLICATIONS

This application is a continuation-in-part of U.S. application Ser. No. 18/379,549, titled “Nail Grinder with Vacuum System and Method of Use,” filed on Oct. 12, 2023, and U.S. application Ser. No. 18/376,232, titled “Pet Grooming Tool with Vacuum System and Method of Use,” filed on Oct. 3, 2023; each of which is a continuation-in-part of U.S. application Ser. No. 18/130,770, titled “Pet Grooming Vacuum System,” filed Apr. 4, 2023, which claims priority to U.S. Application Ser. No. 63/442,326, titled “Pet Grooming Vacuum System,” filed Jan. 31, 2023. This application incorporates the entire contents of the foregoing application herein by reference.

### TECHNICAL FIELD

Various implementations relate generally to a pet grooming kit, and more specifically, to a low-noise vacuum grooming system that may be particularly suited for use in a veterinary surgical suite.

### BACKGROUND

Various grooming tools may be employed to clean and brush pets. Common grooming tools include brushes, combs, trimmers, and the like. Such tools may be used to separate loose pet hair and other debris, such as dirt and pet dander, from the skin and coat of the pet. A vacuum source may be used to provide suction to remove the hair and debris picked up by or released from the grooming tools.

Conventional vacuum sources are often loud (e.g., 90-100 decibels) and may cause distress and anxiety in pets. In addition, the grooming process may be time-consuming, forcing pets to endure a high noise level for extended periods of time.

Pets may be groomed regularly for cosmetic reasons. On occasion, pets may require specialized grooming in conjunction with veterinary procedures, including surgical procedures. For example, hair or fur may be removed or closely shaved prior to surgical procedures; nails or teeth may require trimming; hair may need to be combed or de-tangled; etc.

### SUMMARY

In some implementations, a pet grooming kit includes (a) a canister having a handle, a canister vacuum port, and a screen through which air can pass; (b) a base having a latch configured to releasably secure the canister to the base; a clip; a base vacuum port that is fluidly coupled to the canister vacuum port when the canister is releasably secured to the base; a filter; and a vacuum system that draws a vacuum through the vacuum port, the canister vacuum port, the screen and the filter; (c) a plurality of tools comprising one or more unpowered tools, a powered vacuum clipper, and a powered vacuum multi-head tool that receives either a clipper head or a grinder head; and (d) a flexible hose having a vacuum-engaging end that is configured to be releasably coupled to the vacuum port and that has a vacuum-end power connection, a tool-engaging end that has a tool-end power connection and that is configured to either releasably secure one of the plurality of tools or be releasably secured by the clip, and one or more conductors that electrically couple the vacuum-end power connection and the tool-end power connection.

The handle may be configured to facilitate carrying of the pet grooming kit when the canister is secured to the base. The vacuum-end power connection, the one or more conductors and the tool-end power connection may provide power from the base to the powered vacuum clipper or the powered vacuum multi-head tool when either is releasably coupled to the tool-engaging end and the vacuum-engaging end is releasably coupled to the vacuum port.

The screen may be disposed on a latchable, hinged panel that can be closed for use when the canister is releasably secured to the base or opened for cleaning when the canister is removed from the base.

The filter may include a removable high-efficiency particulate air (HEPA) filter. The filter may further include a secondary foam filter. The pet grooming kit may further include a flexible filter gasket that forms a seal between the base, the HEPA filter and the screen, when the base releasably secures the canister. The pet grooming kit may further include a flexible port gasket that forms a seal between the canister vacuum port and the base when the canister is releasably secured to the base.

The flexible hose may be configured to be secured around the base when the vacuum-engaging end is releasably coupled to the base vacuum port, the flexible hose is wrapped around the base, and the tool-engaging end is releasably secured to the clip.

The base may further include a removable tool caddy that is configured to support multiple tools in the plurality of tools. The one or more unpowered tools may include a grooming brush or a grooming wand.

The vacuum system may have at least a first suction mode in which the vacuum system emits noise at about 52 decibels or less, and a second suction mode that provides greater suction than the first suction mode and in which second suction mode the vacuum system emits noise at about 75 decibels or less.

The powered vacuum clipper may include a clipper head configured to cut hair and a vacuum port adjacent the clipper head configured to vacuum cut hair away from the clipper head and through the flexible hose.

The powered vacuum multi-head tool may include a motor having a compound shaft with a first on-axis portion and a second off-axis portion. The first on-axis portion may be configured to rotate a grinder in the grinder head when the grinder head is received by the vacuum multi-head tool. The second off-axis portion may be configured to drive clippers in the clipper head when the clipper head is received by the vacuum multi-head tool.

The clipper head may include a vacuum port adjacent the clippers and may be configured to vacuum clipped hair away from the clippers and through the powered vacuum multi-head tool. The grinder head may include a vacuum port adjacent the grinder and may be configured to vacuum shavings away from the grinder and through the powered vacuum multi-head tool.

The canister may be cylindrical in shape with a longitudinal axis and may be releasably secured by the base in an upright position in which the longitudinal axis is perpendicular to a bottom of the base. The canister vacuum port may be disposed on an exterior side of a wall of the canister and may be fluidly coupled to a discharge port on an interior side of the wall of the canister. The discharge port may be pointed away from the screen.

In other implementations, a pet grooming kit includes (a) a canister having a handle, a canister vacuum port, and a screen through which air can pass; (b) a base comprising a latch configured to releasably secure the canister to the base; a base vacuum port that is fluidly coupled to the canister vacuum port when the canister is releasably secured to the base; a filter; and a vacuum system that draws a vacuum through the vacuum port, the canister vacuum port, the screen and the filter; (c) a plurality of tools comprising a powered vacuum clipper; and (d) a flexible hose having a vacuum-engaging end that is configured to be releasably coupled to the vacuum port and that has a vacuum-end power connection, a tool-engaging end that has a tool-end power connection and that is configured to releasably secure one of the plurality of tools, and one or more conductors that electrically couple the vacuum-end power connection and the tool-end power connection. The vacuum-end power connection, the one or more conductors and the tool-end power connection may provide power from the base to the powered vacuum clipper when it is releasably coupled to the tool-engaging end and the vacuum-engaging end is releasably coupled to the vacuum port.

In still other implementations, a pet grooming kit includes (a) a canister having a handle, a canister vacuum port, and a screen through which air can pass; (b) a base comprising a latch configured to releasably secure the canister to the base; a base vacuum port that is fluidly coupled to the canister vacuum port when the canister is releasably secured to the base; a filter; and a vacuum system that draws a vacuum through the vacuum port, the canister vacuum port, the screen and the filter; (c) a plurality of tools comprising a powered vacuum multi-head tool that receives either a clipper head or a grinder head; and (d) a flexible hose having a vacuum-engaging end that is configured to be releasably coupled to the vacuum port and that has a vacuum-end power connection, a tool-engaging end that has a tool-end power connection and that is configured to releasably secure one of the plurality of tools, and one or more conductors that electrically couple the vacuum-end power connection and the tool-end power connection. The vacuum-end power connection, the one or more conductors and the tool-end power connection may provide power from the base to the powered vacuum multi-head tool when it is releasably coupled to the tool-engaging end and the vacuum-engaging end is releasably coupled to the vacuum port.

### BRIEF DESCRIPTION OF THE DRAWINGS

FIG. 1 illustrates an exemplary pet grooming kit.

FIGS. 2A-2D illustrate various details of a canister and base in the exemplary pet grooming kit of FIG. 1.

FIG. 3A illustrates details of an exemplary flexible hose.

FIGS. 3B-3C illustrate details of an exemplary base and hose.

FIGS. 4A-4B illustrate details of exemplary filters.

FIGS. 5A-5B illustrate details of an exemplary tool caddy.

FIGS. 6A-6G illustrate details of an exemplary powered vacuum multi-head tool and corresponding interchangeable tool heads.

### DETAILED DESCRIPTION

In some implementations, a pet grooming kit 101 includes a base 104, a canister 107, a flexible hose 110, and a plurality of tools—which may include one or more of a grooming wand 111, a grooming brush 112, a powered vacuum clipper 113 and a powered vacuum multi-head tool 114. In some implementations, as shown, the powered vacuum multi-head tool 114 may receive a small clipper head 115a, a grinder head 115b or a large clipper head 115c.

The pet grooming kit 101 may be configured to be a stand-alone, easily carried kit that provides various tools necessary for a pet grooming professional to clip hair and fur; detangle the same; remove clipped hair, dried skin, insects or other parasites; and trim nails and teeth.

In different implementations, different grooming kits may be particularly suited for different purposes—for example, some kits may be configured for use in general grooming operations, while other kits may be particularly suited for veterinary or surgical applications. In the latter case, for example, additional clippers may be provided relative to general grooming kits (e.g., clippers with finer or smaller blades that may cut hair or fur closer to the skin or better navigate over smaller, more contoured areas of an animal; and multiple clippers may be provided, such as an additional clipper 116).

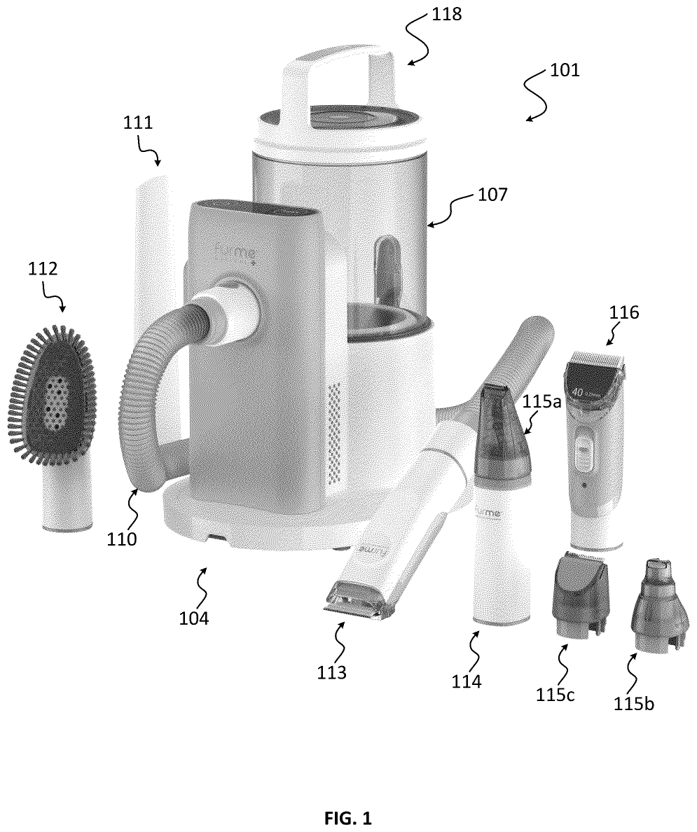

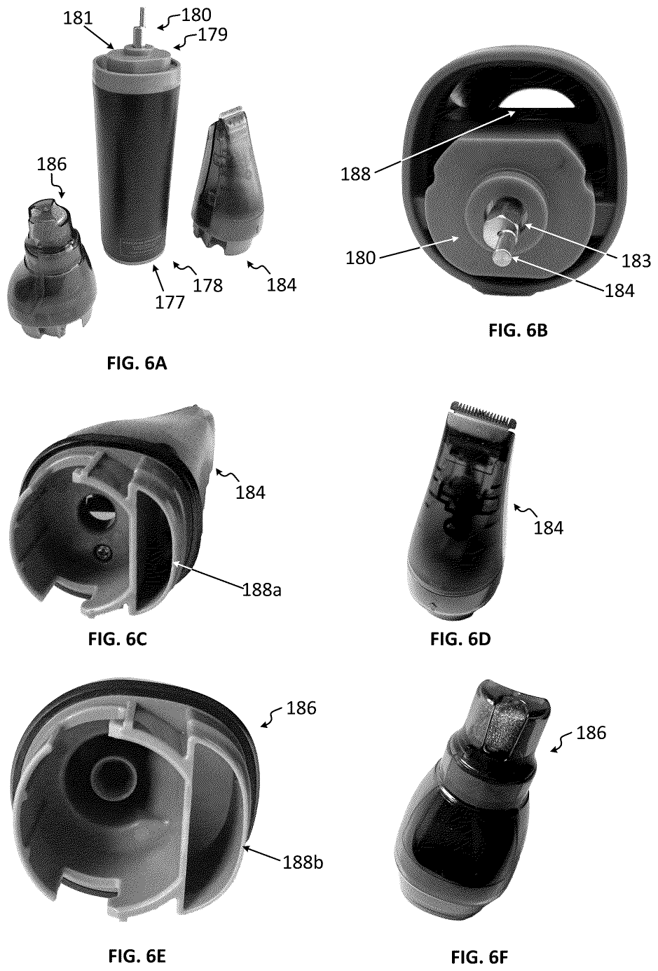

As shown in FIG. 1, a handle 118 may be provided to facilitate carrying of the overall kit 101. The handle 118 may be integrated with the canister 107, such that it can be used to carry the kit 101 when the canister 107 is installed; and the handle 118 may also be used as a stand-alone handle for the canister 107 itself (e.g., to facilitate emptying of contents of the canister 107). A tool caddy (see FIGS. 5A-5B) may also be provided to facilitate carrying of various grooming tools.

In various implementations, the base 104 includes an internally disposed vacuum system (not visible), to which the flexible hose 110 may be coupled on one end, with the other end being coupled to a powered vacuum tool, such as the powered vacuum clipper 113. The vacuum system may be configured to draw a vacuum through the flexible hose 110 and into and through the canister 107 to suck hair, clippings and other debris through the flexible hose 110 and into the canister 107. The canister 107 may be removed for cleaning.

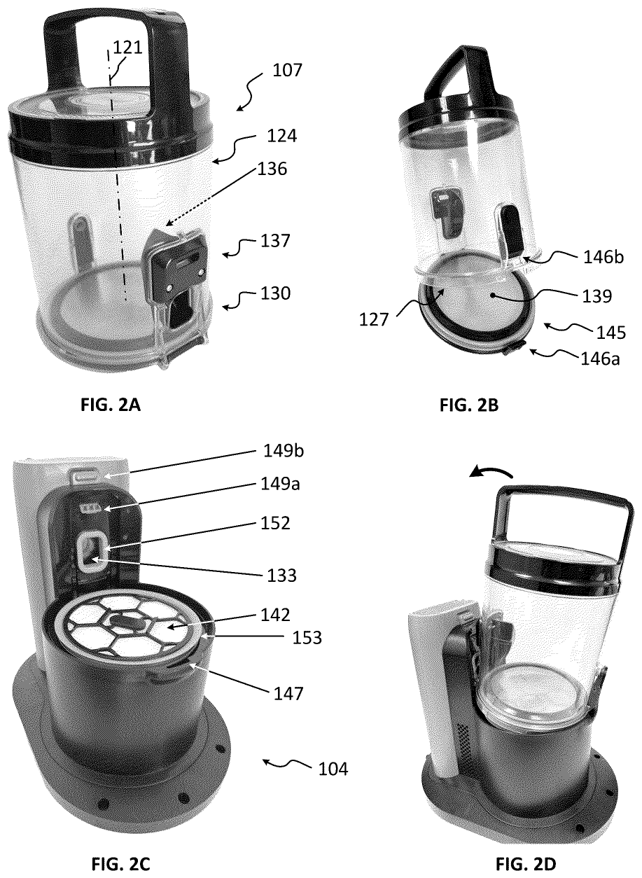

Turning to FIGS. 2A-2D, additional details of the exemplary canister 107 are illustrated and described. In some implementations, as shown, the canister 107 is cylindrical in shape, with a central longitudinal axis 121. The canister 107 includes a wall 124 that encloses an interior space 127, where hair, fur and other debris are collected.

On an exterior of the wall 124, a canister vacuum port 130 is provided, which interfaces with an interior portion of a base vacuum port 133, which is fluidly coupled to the flexible hose 110—when the flexible hose 110 and canister 107 are both coupled to the base 104. The canister vacuum port 130 is coupled to a discharge port 136 on an interior side of the wall 124, and this discharge port 136 may be pointed away from a screen 139 on the bottom of the canister 107. As shown, the screen 139 is disposed adjacent a filter 142 when the canister 107 is installed on the base 104—such that the vacuum system in the base 104 draws a vacuum through the flexible hose 110, base vacuum port 133, canister vacuum port 130 and discharge port 136, through the screen 139 and through the filter 142. The screen 139 may be a durable material, such as metal, that has a mesh-like construction that is designed to capture debris while facilitating airflow through itself.

In some implementations, the screen 139 is disposed on a latchable, hinged panel 145 that allows the canister 107 to be opened and periodically emptied (once it is disengaged from the base 104). In some implementations, a latch 146 maintains the latchable, hinged panel 145 in a closed position or enables it to be opened. The latch 146 may include a latching clip 146a and a latching clasp 146b, and the latching clip 146a may further serve as a hinge point to align the canister 107 as it is installed onto the base 104.

In some implementations, as depicted in FIG. 2D, the canister 107 may be anchored in the base 104 (e.g., in receiver 147) by the latching clip 146a, and the canister 107 may then be rotated toward the base vacuum port 133 (as depicted in FIG. 2D), until the canister 107 is locked into place. The base 104 may further include a latch 149a and release mechanism 149b to selectively engage or disengage the canister 107 (e.g., specifically, the latch receiver 137, shown in FIG. 2A). The latch 149a and release mechanism 149b may be configured to fully support the grooming kit 101 when the canister 107 is installed (i.e., the latch 149a may be configured to securely support the entire grooming kit 101, and the release mechanism 149b may be configured to avoid inadvertent releases). In some implementations, the latch 149a may be held in a latching position by a spring (not shown) and only released when force is applied to the release mechanism 149b; in other implementations, another release mechanism may be applied (e.g., a twist-lock mechanical engagement, a sliding engagement, an electronic or electromagnetic engagement, etc.).

Various gaskets may be provided for sealing different components of the grooming kit 101. For example, a vacuum port sealing gasket 152 may be provided on the base 104 to provide an airtight or nearly airtight seal between the interior base vacuum port 133 and the canister vacuum port 130, when the canister 107 is installed on the base 104. A filter gasket 153 may be provided around a filter 142 to seal the filter 142 into the base 104 and to further seal the canister 107 to the base 104 at and around the screen 139.

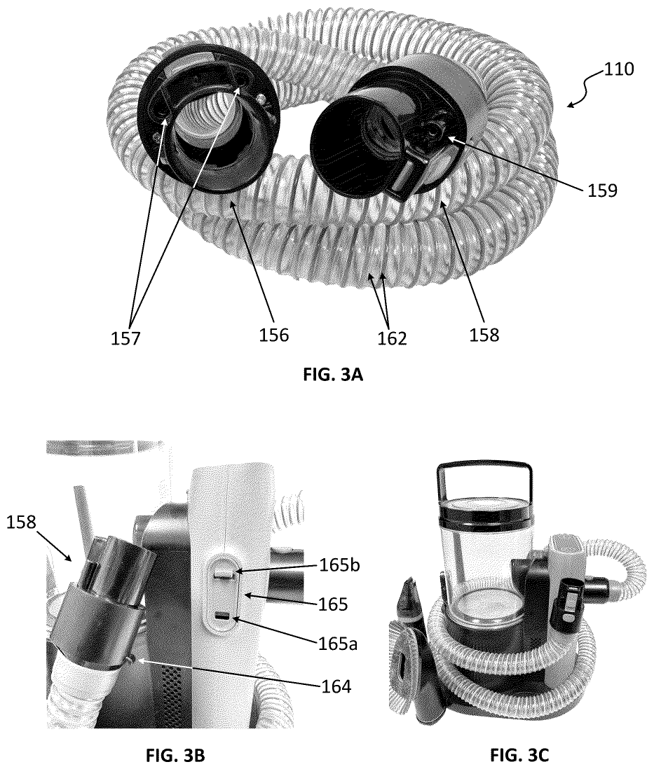

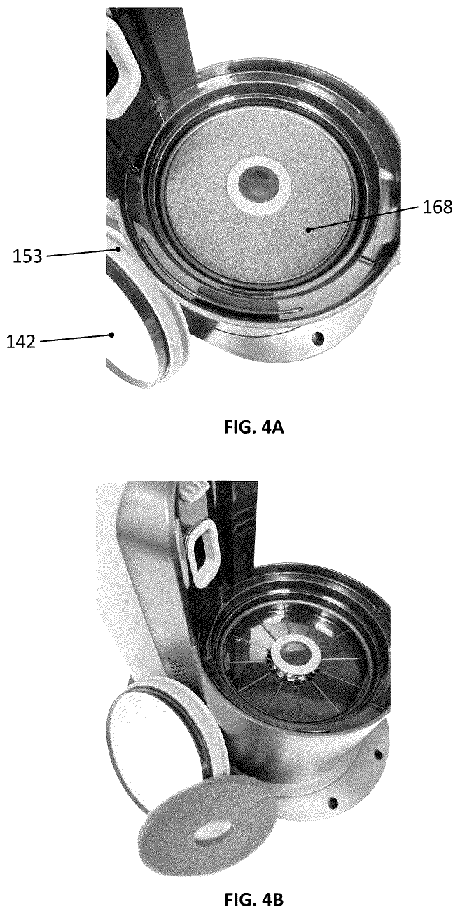

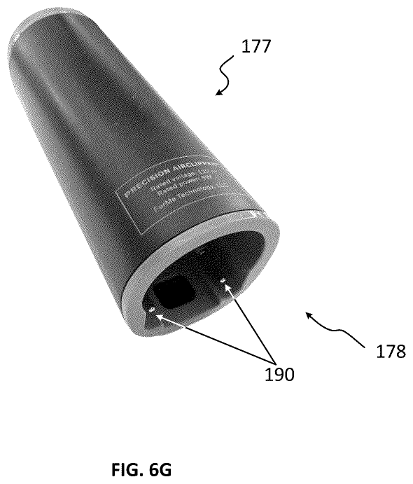

FIGS. 3A-3C illustrate additional details of an exemplary flexible hose 110. The flexible hose 110 includes a vacuum-engaging end 156 and a tool-engaging end 158. In some implementations, the vacuum-engaging end 156 and a tool-engaging end 158 are identical, or very similar; in other implementations, as shown, they are distinct, such that the ends 156 and 158 are not interchangeable but are rather “keyed.” Power connection(s) may be provided at each—for example, a vacuum-end power connection 157 and a tool-end power connection 159. The power connections 157 and 159 may include pin/socket or blade/spade style connections, and they may facilitate electrical connection to mating connectors on the base 104 and on various powered tools. As shown, the power connections 157 and 159 are sockets that are configured to mechanically and electrically mate with pin connectors on the base 104 and on powered tools (e.g., prongs 190, shown in FIG. 6G); but other types of mechanical and electrical connections are possible. Connecting the power connections 157 and 159 are conductors 162. Together, the vacuum-end power connection 157, conductors 162 and tool-end power connection 159, in conjunction with corresponding mating connectors on the base 104 and a powered tool, enable power to be supplied from the base 104 to a powered tool, such as the clipper 113 or multi-head tool 114 shown in FIG. 1.

In one implementation, the tool-engaging end 158 may include a detent 164 that is configured to be secured by a clip 165 on the base. That is, the detent 164 may be received by an aperture 165a in the clip 165, and a spring feature 165b of the clip may engage another portion of tool-engaging end 158. In this implementation, the flexible hose 110 may be secured at its vacuum-engaging end 156 by the base 104; the flexible hose 110 may be wrapped around the grooming kit 101; and the tool-engaging end 158 may be secured by the clip 165—such the grooming kit 101, including its flexible hose 101, can be secured together and easily transported.

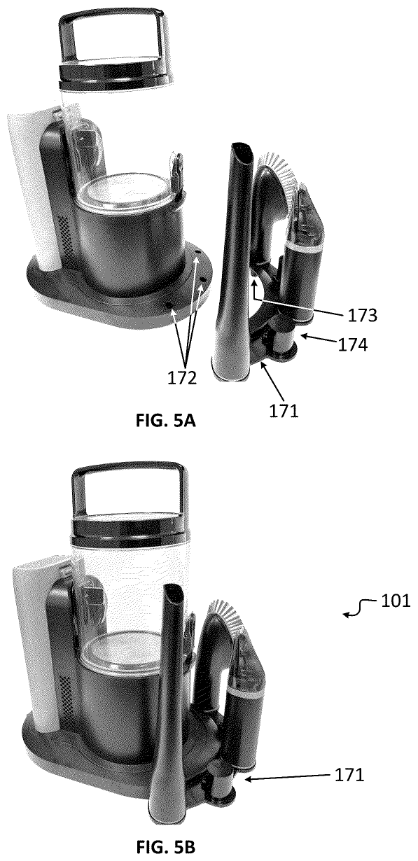

FIGS. 4A-4B illustrate additional detail of exemplary filters. In FIG. 4A, the filter 142 shown in FIG. 2C has been removed. In some implementations, the filter 142 is a high-efficiency particulate air (HEPA) filter, having a pleated construction and disposed in a supporting structure. As described with reference to FIG. 2C, a filter gasket 153 may be provided. In some implementations, a secondary filter 168 is provided (e.g., a sponge or foam filter)—which is shown removed in FIG. 4B.

In some implementations, the specific design of the vacuum system (including its motor (not shown)) and the filter 142, gasket 153, and optional secondary filter 168, may suppress excessive noise that may be otherwise emitted from by the vacuum system. For example, the foregoing components may be designed and configured such that the vacuum system running in a first suction mode (e.g., a “low” setting) may emit noise at about 52 decibels or less (when measured at a standard test distance, such as, for example, 1 m from the device); the foregoing components may be designed and configured such that the vacuum system running in a second suction mode (e.g., a “high” setting) may emit noise at about 75 decibels or less. By configuring the grooming kit 101 to minimize its sound output, pets or other animals on which the grooming kit 101 is used may be less distressed or startled than by grooming kits or systems having greater sound output.

FIGS. 5A-5B illustrate a tool caddy 171 that may be included in some implementations. As shown, the tool caddy 171 may be removable. That is, receiving holes 172 may be provided in the base 104 that are configured to receive posts (e.g., post 173) in the tool caddy 171. The caddy 171 itself may include posts (e.g., post 174) to receive an end of each tool that is configured to be coupled to the flexible hose 110. The post 174 may be tapered and have at its base substantially the same diameter and shape as an opening in each tool that is configured to receive the flexible hose 110. In this manner, each post 174 may secure a tool with a friction fit. In some implementations, the caddy 171 may be removable by a user; in other implementations, the caddy 171 may be fixed to the base 104. FIG. 5B illustrates the grooming kit 101 with the caddy 171 installed.

FIG. 1 illustrates various tools, including unpowered vacuum tools, such as the grooming wand 111 and grooming brush 112. Each may be configured to be coupled to the flexible hose 110 for removal of hair, fur and other debris. Powered vacuum tools may be provided as well, and exemplary powered vacuum tools are now described with reference to FIGS. 6A-6G.

FIGS. 6A-6G illustrates an exemplary powered vacuum multi-head tool 177 having a hose-receiving end 178 and a drive-shaft end 179, from which a drive shaft 180 exits from a motor housing 181, which houses a motor that spins the drive shaft 180. The drive shaft 180 is configured to drive multiple different heads, including, for example, a clipper head 184 or a grinder head 186. The powered vacuum multi-tool 177 includes a vacuum port 188 that couples with a corresponding vacuum port 188a on the clipper head 184, or a corresponding vacuum port 188b on the grinder head 186. The vacuum ports 188a and 188b are configured to vacuum hair, fur, clippings or other material that is removed by the corresponding heads 184 and 186, through said vacuum ports 188a and 188b, through the vacuum port 188 on the multi-head tool 177, and into the flexible hose 110 for removal by the grooming kit 101.

In some implementations, as shown, the drive shaft 180 is a compound shaft 180 having a first on-axis portion 183 and a second off-axis portion 184. The first on-axis portion 183 may drive heads with rotating tools, such as the grinder head 186; and the second off-axis portion 184 may drive heads with reciprocating tools, such as the clipper head 184. The heads 184 and 186 may be configured to snap onto the powered vacuum multi-head tool 177, e.g. with tabs, detents and/or a friction fit. The tool in each head may interface with either the first on-axis portion 183 or the second off-axis portion 184 of the driveshaft 180 and be powered by a motor (not directly shown, but in the motor housing 181) when the powered vacuum multi-head tool 177 is coupled to the flexible hose 110 and powered by the conductors therein. Specifically, power may be received by the powered vacuum multi-head tool 177 through prongs 190 (see FIG. 6G) that engage with the previously described tool-end power connection 159 (see FIG. 3A).

Other powered tools may be provided. For example, with reference to FIG. 1, single-function clippers 113 or 116 may be provided (without interchangeable heads 184 and 186 shown in FIG. 6A). Construction of such other tools may be similar to those described herein— with power connections, vacuum ports and rotating or reciprocating tool heads that can provide various grooming or other functions.

As used herein, “about,” “approximately” or “substantially” may mean within 1%, or 5%, or 10%, or 20%, or 50%, or 100% of a nominal value. Several implementations have been described with reference to exemplary aspects, but it will be understood by those skilled in the art that various changes may be made and equivalents may be substituted for elements thereof without departing from the contemplated scope. For example, latches and release mechanisms may take different forms than described, and any mechanism may be employed that selectively engages and disengages through spring action, lever action, rotation action, friction fit, etc.; canisters may be other than cylindrical in shape or may have different axes or lack symmetry; gaskets and filters may be differently arranged or shaped and may include any suitable material; electrical connections may be made with pin/socket connectors, blade/spade connections, jack/plug connections, or other suitable connections; grooming blades (e.g., in trimmers) may be plastic, metal, ceramic or some combination thereof, and they may be configured to have different cutting angles to cut or trim hair or fur closer or farther from the skin; sealing gaskets may be made from any suitable material, such as rubber, silicone, etc.

Many other variations are possible, and modifications may be made to adapt a particular situation or material to the teachings provided herein without departing from the essential scope thereof. Therefore, it is intended that the scope include all aspects falling within the scope of the appended claims.

What is claimed is:

1. A pet grooming kit, comprising:
a canister having a handle, a canister vacuum port, and a screen through which air can pass;
a base comprising a latch configured to releasably secure the canister to the base;
a clip; a base vacuum port that is fluidly coupled to the canister vacuum port when the canister is releasably secured to the base; a filter; and a vacuum system that draws a vacuum through the vacuum port, the canister vacuum port, the screen and the filter;
a plurality of tools comprising one or more unpowered tools, a powered vacuum clipper, and a powered vacuum multi-head tool that receives either a clipper head or a grinder head; and
a flexible hose having a vacuum-engaging end that is configured to be releasably coupled to the vacuum port and that has a vacuum-end power connection, a tool-engaging end that has a tool-end power connection and that is configured to either releasably secure one of the plurality of tools or be releasably secured by the clip, and one or more conductors that electrically couple the vacuum-end power connection and the tool-end power connection;
wherein the handle is configured to facilitate carrying of the pet grooming kit when the canister is secured to the base; and
wherein the vacuum-end power connection, the one or more conductors and the tool-end power connection provide power from the base to the powered vacuum clipper or the powered vacuum multi-head tool when either is releasably coupled to the tool-engaging end and the vacuum-engaging end is releasably coupled to the vacuum port.

2. The pet grooming kit of claim 1, wherein the screen is disposed on a latchable, hinged panel that can be closed for use when the canister is releasably secured to the base or opened for cleaning when the canister is removed from the base.

3. The pet grooming kit of claim 1, wherein the filter comprises a removable high-efficiency particulate air (HEPA) filter.

4. The pet grooming kit of claim 3, wherein the filter further comprises a secondary foam filter.

5. The pet grooming kit of claim 3, further comprising a flexible filter gasket that forms a seal between the base, the HEPA filter and the screen, when the base releasably secures the canister.

6. The pet grooming kit of claim 1, wherein the flexible hose is configured to be secured around the base when the vacuum-engaging end is releasably coupled to the base vacuum port, the flexible hose is wrapped around the base, and the tool-engaging end is releasably secured to the clip.

7. The pet grooming kit of claim 1, wherein the base further comprises a removable tool caddy that is configured to support multiple tools in the plurality of tools.

8. The pet grooming kit of claim 1, wherein the vacuum system has at least a first suction mode in which the vacuum system emits noise at about 52 decibels or less, and a second suction mode that provides greater suction than the first suction mode and in which second suction mode the vacuum system emits noise at about 75 decibels or less.

9. The pet grooming kit of claim 1, wherein the powered vacuum clipper comprises a clipper head configured to cut hair and a vacuum port adjacent the clipper head configured to vacuum cut hair away from the clipper head and through the flexible hose.

10. The pet grooming kit of claim 1, wherein the powered vacuum multi-head tool comprises a motor having a compound shaft with a first on-axis portion and a second off-axis portion; wherein the first on-axis portion is configured to rotate a grinder in the grinder head when the grinder head is received by the vacuum multi-head tool, and wherein the second off-axis portion is configured to drive clippers in the clipper head when the clipper head is received by the vacuum multi-head tool.

11. The pet grooming kit of claim 10, wherein the clipper head comprises a vacuum port adjacent the clippers and is configured to vacuum clipped hair away from the clippers and through the powered vacuum multi-head tool.

12. The pet grooming kit of claim 10, wherein the grinder head comprises a vacuum port adjacent the grinder and is configured to vacuum shavings away from the grinder and through the powered vacuum multi-head tool.

13. The pet grooming kit of claim 1, wherein the canister is cylindrical in shape with a longitudinal axis and is releasably secured by the base in an upright position in which the longitudinal axis is perpendicular to a bottom of the base.

14. The pet grooming kit of claim 1, wherein the canister vacuum port is disposed on an exterior side of a wall of the canister and is fluidly coupled to a discharge port on an interior side of the wall of the canister.

15. The pet grooming kit of claim 14, wherein the discharge port is pointed away from the screen.

16. The pet grooming kit of claim 1, further comprising a flexible port gasket that forms a seal between the canister vacuum port and the base when the canister is releasably secured to the base.

17. The pet grooming kit of claim 1, wherein the one or more unpowered tools include a grooming brush or a grooming wand.

18. A pet grooming kit, comprising:
a canister having a handle, a canister vacuum port, and a screen through which air can pass;
a base comprising a latch configured to releasably secure the canister to the base; a base vacuum port that is fluidly coupled to the canister vacuum port when the canister is releasably secured to the base; a filter; and a vacuum system that draws a vacuum through the vacuum port, the canister vacuum port, the screen and the filter;
a plurality of tools comprising a powered vacuum clipper; and
a flexible hose having a vacuum-engaging end that is configured to be releasably coupled to the vacuum port and that has a vacuum-end power connection, a tool-engaging end that has a tool-end power connection and that is configured to releasably secure one of the plurality of tools, and one or more conductors that electrically couple the vacuum-end power connection and the tool-end power connection;
wherein the handle is configured to facilitate carrying of the pet grooming kit when the canister is secured to the base; and
wherein the vacuum-end power connection, the one or more conductors and the tool-end power connection provide power from the base to the powered vacuum clipper when it is releasably coupled to the tool-engaging end and the vacuum-engaging end is releasably coupled to the vacuum port.

19. A pet grooming kit, comprising:
a canister having a handle, a canister vacuum port, and a screen through which air can pass;
a base comprising a latch configured to releasably secure the canister to the base; a base vacuum port that is fluidly coupled to the canister vacuum port when the canister is releasably secured to the base; a filter; and a vacuum system that draws a vacuum through the vacuum port, the canister vacuum port, the screen and the filter;
a plurality of tools comprising a powered vacuum multi-head tool that receives either a clipper head or a grinder head; and
a flexible hose having a vacuum-engaging end that is configured to be releasably coupled to the vacuum port and that has a vacuum-end power connection, a tool-engaging end that has a tool-end power connection and that is configured to releasably secure one of the plurality of tools, and one or more conductors that electrically couple the vacuum-end power connection and the tool-end power connection;
wherein the handle is configured to facilitate carrying of the pet grooming kit when the canister is secured to the base; and
wherein the vacuum-end power connection, the one or more conductors and the tool-end power connection provide power from the base to the powered vacuum multi-head tool when it is releasably coupled to the tool-engaging end and the vacuum-engaging end is releasably coupled to the vacuum port.
